(19) United States
(12) Patent Application Publication
(10) Pub. No.: US 2024/0409247 A1
(43) Pub. Date: Dec. 12, 2024

(54) ADJUSTABLE ARM MOUNT AND DATA TRANSMISSION MODULE

(71) Applicant: The MITRE Corporation, McLean, VA (US)

(72) Inventors: Matthew Anthony RYDER, Chelmsford, MA (US); Steven Gray King, Reston, VA (US); Dong-Jin Shim, Niskayuma, NY (US)

(73) Assignee: The MITRE Corporation, McLean, VA (US)

(21) Appl. No.: 18/734,359

(22) Filed: Jun. 5, 2024

Related U.S. Application Data
(60) Provisional application No. 63/472,211, filed on Jun. 9, 2023.

(51) Int. Cl. B64U 20/80; B64U 101/20

(52) U.S. Cl. CPC B64U 20/80; B64U 2101/20

(57) ABSTRACT

An adjustable support comprising a plurality of support portions, and at least one joint connecting adjacent support portions of the plurality of support portions and configured so that the adjacent support portions can be positioned in different positions relative to one another. The at least one joint comprising a first portion and a second portion, the first portion comprising a polygonal extension and the second portion comprising a polygonal recess for receiving the polygonal extension of the first portion, wherein the polygonal extension can be received in the polygonal recess in different rotational positions to position the adjacent support portions in the different positions relative to one another, and the at least one joint further comprising a retainer to force the first and second portions together.

### CROSS-REFERENCE TO RELATED APPLICATIONS

This application claims the benefit of U.S. Provisional Application No. 63/472,211, filed Jun. 9, 2023, the entire contents of which is incorporated herein by reference.

### TECHNICAL FIELD

This disclosure generally relates to data transfer, and more specifically, to transferring data from a movable source.

### BACKGROUND OF THE DISCLOSURE

Sensors for detecting potential hazards may be carried into a potentially hazardous environment by being strapped to an aerial vehicle which is then flown into the environment. While the aerial vehicle may be able to support the sensor while flying, the aerial vehicle may not have a dedicated position for the sensor to attach to. As a result, the sensor may be attached to various positions of the aerial vehicle. This may affect the flight performance of the aerial vehicle and may also interfere with the sensor being able to measure its environment efficiently. Various mounts may be used as an intermediary for attaching the sensor to the aerial vehicle, but the mounts may not be designed for supporting payloads on an aerial vehicle. The sensor data may also need to be transmitted to a remote location for processing and storage. However, as the aerial vehicle carries the sensor to various locations to generate sensor data, the sensor's preconfigured communication modules may not have the range to be able to transmit to the remote locations.

### SUMMARY OF THE DISCLOSURE

The present disclosure introduces an adjustable arm mount that may include a plurality of support portions or arm segments. The arm segments may be connected to each other by one or more joints. Each joint may include a first and second portion or component. One of the joint components may include a polygonal protrusion and the other joint component may include a polygonal recess for receiving the polygonal protrusion. The joint components may be positioned in various rotational positions relative to one another which may allow the components attached to the join, such as the arm segments, to also be positioned in different positions relative to one another. The joint may also include a retainer that forces the two joint components together. The adjustable arm mount may be used to attach various payloads to different support structures, such as a sensor payload to an aerial vehicle. As the aerial vehicle brings the sensor to different locations, the sensor may generate sensor data. The sensor data may be broadcasted via a first communication channel and received by a data transmission module, which may also be carried by the adjustable arm. The data transmission module may convert the sensor data to a format transmittable via a second communication channel and then transmit the sensor data to a base station via the second communication channel.

In various embodiments, an adjustable support includes a plurality of support portions, and at least one joint connecting adjacent support portions of the plurality of support portions and configured so that the adjacent support portions can be positioned in different positions relative to one another. The at least one joint includes a first portion and a second portion, the first portion includes a polygonal extension and the second portion includes a polygonal recess for receiving the polygonal extension of the first portion, wherein the polygonal extension can be received in the polygonal recess in different rotational positions to position the adjacent support portions in the different positions relative to one another, and the at least one joint further includes a retainer to force the first and second portions together.

Optionally, the adjacent support portions include a mount for mounting the adjustable support to a support structure.

Optionally, the support structure includes a vehicle.

Optionally, the vehicle is an unmanned aerial vehicle (UAV).

Optionally, the mount is configured to mount to a leg of the UAV.

Optionally, the mount for mounting the adjustable support to a support structure is a first mount, and the adjustable support includes a second mount for mounting a sensor so that the sensor can be carried by the UAV.

Optionally, the first portion of the joint or the second portion of the joint is formed into the mount.

Optionally, the first portion includes a plurality of polygonal extensions.

Optionally, the second portion includes a polygonal extension.

Optionally, the adjacent support portions include an arm member that includes a polygonal recess for receiving an additional polygonal extension of the first portion of the joint or the second portion of the joint.

Optionally, the adjacent support portions include two arm members extending in parallel, wherein each arm member includes a polygonal recess for receiving a corresponding additional polygonal extension of the first portion of the joint or the second portion of the joint.

In various embodiments, a system for transferring data from one or more sensors to a remote receiving station includes a first communication interface for communicating with the one or more sensors via a first communication channel, wherein the first communication channel is capable of transmitting data at a first distance. The system further includes a second communication interface for communicating with the remote receiving station via a second communication channel, wherein the second communication channel is capable of transmitting data at a second distance greater than the first distance. The system further includes a computing device coupled to the first and second communication interfaces and configured to receive sensor data from the one or more sensors via the first communication interface, wherein the sensor data is received in a first format corresponding to the first communication channel, wherein the computing device is configured to convert the sensor data from the first format to a second format corresponding to the second communication channel, and wherein the computing device is further configured to transmit the sensor data in the second format to the remote receiving station via the second communication interface.

Optionally, the first communication channel is a Bluetooth channel.

Optionally, the second channel is a low-power long-range (LoRa) radio channel.

Optionally, an intervening distance between the one or more sensors and the remote receiving station is greater than the first distance and less than or equal to the second distance.

Optionally, the one or more sensors are mounted to an unmanned aerial vehicle (UAV).

Optionally, the second communication channel is separate from a software module or communication module associated with the support structure.

Optionally, one or more of the first communication interface, the second communication interface, and the computing device are mounted to the UAV.

Optionally, the system further includes a battery that supplies electrical power to one or more of the first communication interface, the second communication interface, and the computing device, wherein the battery is separate from the UAV.

Optionally, the remote receiving station comprises software to associate a Global Positioning System (GPS) location of the one or more sensors to the sensor data, wherein the GPS location corresponds to where the sensor data was generated by the one or more sensors.

Optionally, the system further includes an enclosure around one or more of the first communication interface, the second communication interface, and the computing device to protect against electrical hazards.

Optionally, the computing device is a system-on-chip (SoC).

### BRIEF DESCRIPTION OF THE FIGURES

The invention will now be described, by way of example only, with reference to the accompanying drawings, in which:

FIG. 1A illustrates a perspective view of an aerial vehicle with an adjustable arm mount.

FIG. 1B illustrates a schematic of the aerial vehicle with the adjustable arm mount.

FIGS. 2A-2B illustrate perspective views of exemplary adjustable arm mounts.

FIGS. 3A-3B illustrate wireframes of a section of an adjustable arm mount in two rotational positions.

FIGS. 4A-4B illustrate wireframes of a joint with two joint components in two rotational positions.

FIG. 5A illustrates a side view wireframe of a joint with two joint components.

FIG. 5B illustrates a perspective view wireframe of two joint components with a male and female joint interface.

FIG. 5C illustrates a perspective view wireframe of the cross-section of two joint components with the male and female joint interfaces.

FIG. 5D illustrates a perspective view of the joint components with a male and female join interface.

FIG. 6 illustrates a schematic of a data transmission module that transfers data from a sensor to a base station.

FIG. 7 illustrates a method for transferring data from a sensor to a remote base station.

FIG. 8 illustrates an example computer system.

### DESCRIPTION OF EXAMPLE EMBODIMENTS

The present disclosure describes an adjustable arm mount that may be attached to various support structures, such as the legs of an aerial vehicle. The adjustable arm mount may include an end effector, such as a clamp, that secures the arm mount to the support structure. The adjustable arm mount may also include a mounting location where various payloads may be attached to the adjustable arm mount. The adjustable arm mount may include a plurality of support portions or arm segments. The arm segments may be connected to one another via joints that allow the arm segments to be rotatable such that the arm segments may be positioned in various configurations. The joint may include different portions or components, where one component includes a polygonal protrusion that interfaces with a corresponding polygonal recess in the other component. The polygonal extension can be received in the polygonal recess in different rotational positions, which allows for a rigid joint connection that reduces the chance of slip. The joint may also include a retainer that forces the different joint portions or components together.

The adjustable arm mount may be used to attach various payloads to different support structures. For example, the adjustable arm mount may be used to attach a sensor payload to an aerial vehicle such that the aerial vehicle brings the sensor to different locations. The sensor may measure different characteristics of the environment and generate corresponding sensor data. The sensor data may be broadcast via a first communication channel with a limited communication range. A data transmission module may communicate with the sensor via the first communication channel to receive the sensor data. The data transmission module may then convert the sensor data to a format that is transmittable via a second communication channel with a longer communication distance than the first communication channel. The data transmission module may then transmit the sensor data via the second communication channel to a base station.

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing distinct functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

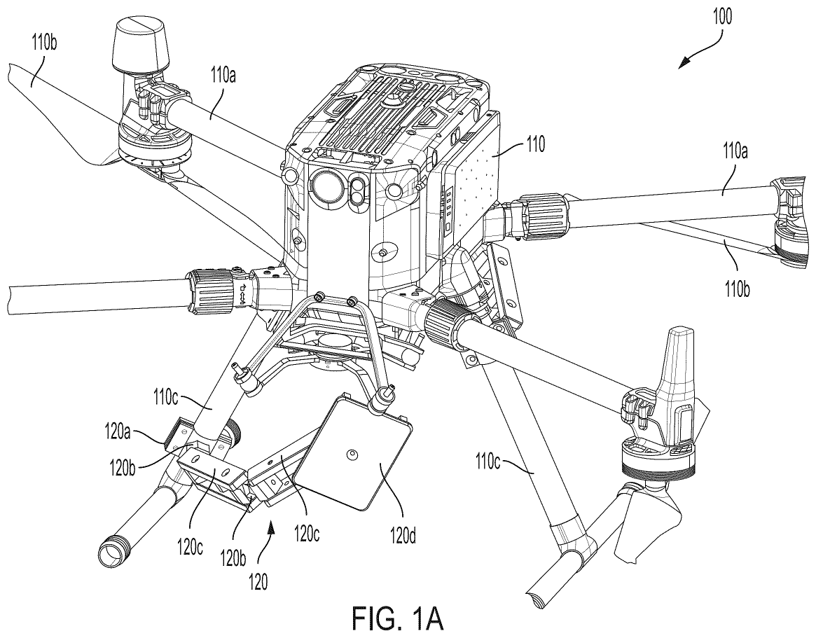

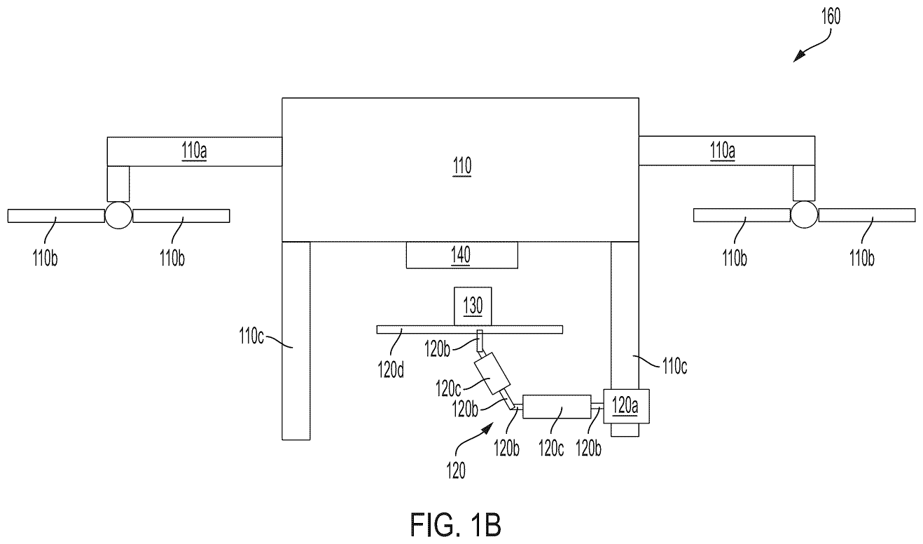

FIG. 1A illustrates a perspective view 100 of an aerial vehicle 110 with an adjustable arm mount 120. The aerial vehicle 110 may be a drone, a manned, or an unmanned aerial vehicle (UAV). The aerial vehicle 110 may include motor arms 110a with motors that provide power to the propellers 110b and one or more legs 110c. The adjustable arm mount 120 may be illustrated as being attached to an aerial vehicle 110, but it may be noted that the arm mount 120 may be attached to various support structures as allowed by the arm mount 120, such as support columns or pillars or land vehicles.

As illustrated, an adjustable arm mount 120 is attached to one of the legs 110c of the aerial vehicle 110. The adjustable arm mount 120 may include an end effector 120a that secures the arm mount 120 to the leg 110c. The end effector 120a may be a clamp that secures to the tubular structure of the aerial vehicle's leg 110c, but various other components may also be appropriate. In various embodiments, the size of the end effector 120a may be adjusted to allow the end effector 120a to attach to various objects of different sizes. That is, and continuing with the example of the end effector 120a being implemented as a clamp, the bore of the clamp may be increased or decrease to allow the clamp to secure to objects of different sizes, such as the legs of different aerial vehicles that may be tubular structures with different diameters.

The end effector 120a may connect to an arm segment 120c via a joint 120b, where the joint 120b may include one or more joint components, as described further herein. The arm segment 120c may be implemented using various objects, such as plates that are flat and elongated in shape. Multiple arm segments 120c may also be connected to each other via one or more joints 120b. As illustrated in FIG. 1A, two arm segments 120c may be connected to each other via a joint 120b. The joints 120b that connect the arm segments 120c may allow the arm segments 120c to be rotatable such that the arm segments 120c may be positioned in various configurations.

The adjustable arm mount 120 may also include a mounting location 120d where a payload may be attached to. The mounting location 120d may be implemented as any appropriate structure capable of attaching a corresponding payload. For example, the mounting location 120d may be a clamp or a mounting plate as illustrated in FIG. 1A.

FIG. 1B illustrates a schematic 160 of the aerial vehicle 110 with the adjustable arm mount 120. As described above, the aerial vehicle 110 may include motor arms 110a with motors that provide power to the propellers 110b and one or more legs 110c.

An adjustable arm mount 120 may be attached to one of the legs 110c of the aerial vehicle 110. The adjustable arm mount 120 may include an end effector 120a that secures the arm mount to the leg 110c. The end effector 120a may be connected to an arm segment 120c via a joint 120b. The arm mount 120 may include multiple arm segments 120c connected to each other via one or more joints 120b. The joints 120b may also include one or more joint components. The adjustable arm mount 120 may also include a mounting location 120d for attaching payloads. The mounting location 120d may be connected to an arm segment 120c via a joint 120b.

As illustrated in FIG. 1B, the mounting point 120d may be used to attach a payload. The payload can be, for example, a sensor 130, but many other payloads may be attached to the mounting point 120d in various embodiments. The sensor 130 may be an existing off-the-shelf sensor unit, such as a handheld sensor unit. The handheld sensor may be preconfigured to be used by a user and may include a display and a user interface with various controls that a user may interact with to adjust characteristics of the sensor. As described above, the joints 120b that connect the arm segments 120c may allow the arm segments to be rotatable such that they may be positioned in various configurations. This may allow the arm segments 120c to be configured to form the shape as illustrated in FIG. 1B which causes the arm mount 120 to extend from the legs 110c of the aerial vehicle 110 towards the center of the aerial vehicle. The illustrated configuration of the arm segments 120c may allow the arm mount 120 to position the payload, which may include the sensor 130, under the center of gravity of the aerial vehicle 110. Another configuration of the arm segments 120c may allow the arm mount 120 to extend from the legs 110c away from the center of the aerial vehicle 110, such that the arm mount 120 is cantilevering a payload at a distance from the center of the aerial vehicle.

The various configurations of the arm segments 120c may provide various advantages when applying the adjustable arm mount 120, such as in the case with an aerial vehicle 110. For example, a configuration of the arm segments 120c like that illustrated in FIG. 1B that allows a payload to be positioned below the center of gravity of the aerial vehicle 110 may help improve the flying performance of the aerial vehicle, such as in terms of flight control or flight endurance. On the other hand, a configuration of the arm segments 120c that positions a payload away from the center of the aerial vehicle 110 may allow the aerial vehicle 110 to carry a payload without interfering with the function of the payload. Specifically, the payload may include a sensor 130, which may be a gas sensor for detecting various gases that may be in the atmosphere. As such, the arm segments 120c may be configured to position the payload away from the center of the aerial vehicle 110 to allow the sensor 130 to positioned outside the downdraft from the aerial vehicle's propellers 110b.

Referring back to FIG. 1B, a computing system 140 may be attached to the aerial vehicle 110. In various embodiments, the computing system 140 may be the payload that is mounted to the adjustable arm mount 120 via the mounting point 120d, but the computing system 140 may also be a separate payload that is attached to the aerial vehicle 110. The computing system 140 may help data that is generated or detected by the payload of the arm mount 120, such as the sensor 130, to another location that may be outside the communication range inherently supported by the data generating components like the sensor 130. The computing system 140 may include various components, which are described further herein, that interact with the sensor 130 without interfering with the operation of the aerial vehicle 110 transporting the payload.

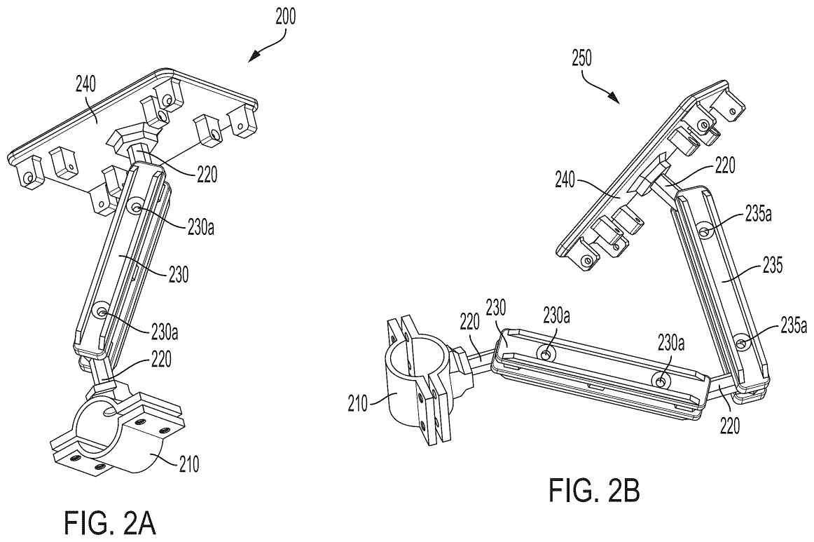

FIGS. 2A-2B illustrate perspective views of exemplary adjustable arm mounts 200 and 250. Adjustable arm mounts may include various numbers of arm segments, with the adjustable arm mount 200 of FIG. 2A including one arm segment and the adjustable arm mount 250 of FIG. 2B including two arm segments. Starting with FIG. 2A, the arm mount 200 may include an end effector 210 that secures the arm mount to a corresponding support structure, such as the leg of an aerial vehicle 110. The end effector 210 may be implemented as a clamp with a tubular bore that allows the clamp to secure to tubular support structures. The size of the tubular bore may also be adjusted to allow the end effector 210 to be able to secure to tubular support structures of different sizes. In various embodiments, the end effector 210 may correspond to the end effector 120a of FIGS. 1A and 1B.

The end effector 210 may be connected to the arm segment 230 via a joint 220. The joint 220 may include multiple components, which are described further herein, to help provide a rigid and secure connection between the various components of the arm mount 200. In various embodiments, the arm segment 230 may include parallel plates that are secured in place by attaching to the joints 220. The plates of the arm segment 230 may also include bores 230a along the length of the plates where struts, such as rods or bars, may be positioned to provide additional structural support to the arm segment 230 and the arm mount 200. The struts positioned in the bores 230a may also help secure the mechanical plates of the arm segment 230 in place. The arm mount 200 may also include a mounting location 240 where payloads may be attached to. The joints 220 may allow the components they connect to be rotatable and thus positioned in various configurations. Specifically, the end effector 210 may be rotatable with respect to the arm segment 230 about the point where the arm segment connects to the joint 220 between the arm segment 230 and the end effector 210. Similarly, the mounting location 240 may be rotatable with respect to eh arm segment 230 about the point where the arm segment connects to the join 220 between the arm segment 230 and the mounting location 240. In various embodiments, the joints 220 may correspond to the joints 120b of FIGS. 1A and 1B, the arm segment 230 may correspond to the arm segments 120c of FIGS. 1A and 1B, and the mounting location 240 may correspond to the mounting location 120d of FIGS. 1A and 1B.

Referring to FIG. 2B, the adjustable arm mount 250 may be mostly similar to the adjustable arm mount 200 of FIG. 2A, but with an additional arm segment. That is, the adjustable arm mount 250 may include an end effector 210 for securing the arm mount to a support structure. The end effector 210 may be connected to a first arm segment 230 via a joint 220, where the first arm segment 230 may be connected to a second arm segment 235 via another joint 220. The first and second arm segments 230 and 235 may also include bores 230a and 235a, respectively, where mechanical struts may be positioned to provide additional structural support to the arm segments 230 and 235 themselves and the arm mount 250. The second arm segment 235 may also be connected to a mounting location 240 via another joint 220, where the mounting location 240 may be where various payloads are attached to the arm mount 250.

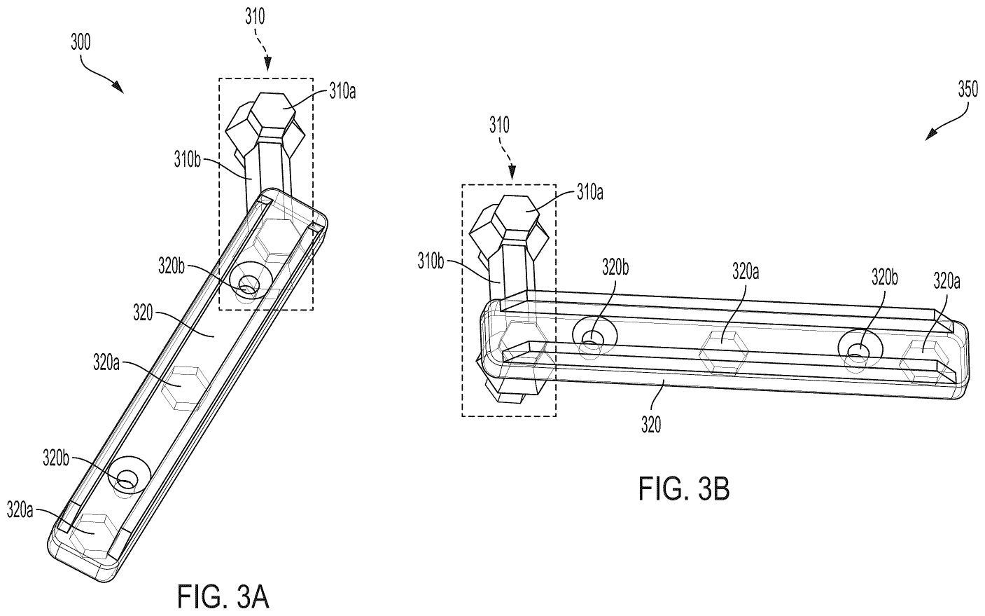

FIGS. 3A-3B illustrate wireframes of a section of an adjustable arm mount in two rotational positions 300 and 350. Referring first to FIG. 3A, the section of the adjustable arm mount as illustrated may include a joint 310 with a first joint component 310a and a second joint component 310b, and an arm segment 320 that is attached to the joint 310 at the second joint component 310b. In various embodiments, the joint 310 may correspond to the joints 120b and 220 of FIGS. 1A-2B. The first and second joint components 310a and 310b may be attached to each other through a protrusion in one joint component inserting into a corresponding recess of the other joint component in a male-female interface, which is described further below. The first and second joint components 310a and 310b may also each include protrusions that insert into a corresponding recess of the arm segment 320, such as the recesses 320a, to secure the arm segment 320 to one of the first and second joint components 310a and 310b. To differentiate the protrusions of the joint components that attach the joint components to each other from the protrusions that attach the joint components to arm segments, the protrusion and corresponding recess for the former may be referenced herein as the male joint interface and the female joint interface, while the protrusion and corresponding recess for the latter may be referenced as the joint component protrusion and the joint recess of the arm segment.

This means that the first joint component 310a may include a female joint interface that interacts with a male joint interface of the second joint component 310b that allows the first and second joint components 310a and 310b to attach and secure to one another. Each of the first and second joint components 310a and 310b may also include a joint component protrusion that may interface with a corresponding joint recess of another component to attach and secure the component to the joint component. In the example of FIG. 3A, the arm segment 320 may include multiple joint recesses 320a where the arm segment 320 may attach to the second joint component 310b. That is, the joint component protrusion of the second joint component 310b may insert into a joint recess 320a of the arm segment which allows the arm segment 320 to attach and secure to the second joint component 310b.

The arm segment 320 as illustrated may be one of the rectangular plates that are used to implement the arm segment. The arm segment 320 may include another rectangular plate that is the same as the plate shown and is positioned parallel to the illustrated plate. The plate of the arm segment 320 may include bores 320b where struts may be positioned to secure the two parallel plates in place relative to each other, which may also provide additional structural support to the arm segment 320.

In FIG. 3B, the arm segment 320 may be rotated to a different position that the position illustrated in FIG. 3A. As illustrated, the position of the arm segment 320 in FIG. 3B may be rotated about the point where the arm segment 320 attaches to the second joint component 310b. In various embodiments, the arm segment 320 may be able to rotate about the attachment point with the second joint component 310b while remaining attached to the second joint component, but in various other embodiments, the rotation may include detaching the arm segment 320, rotating the arm segment to a new position, and then reattaching the arm segment to the second joint component.

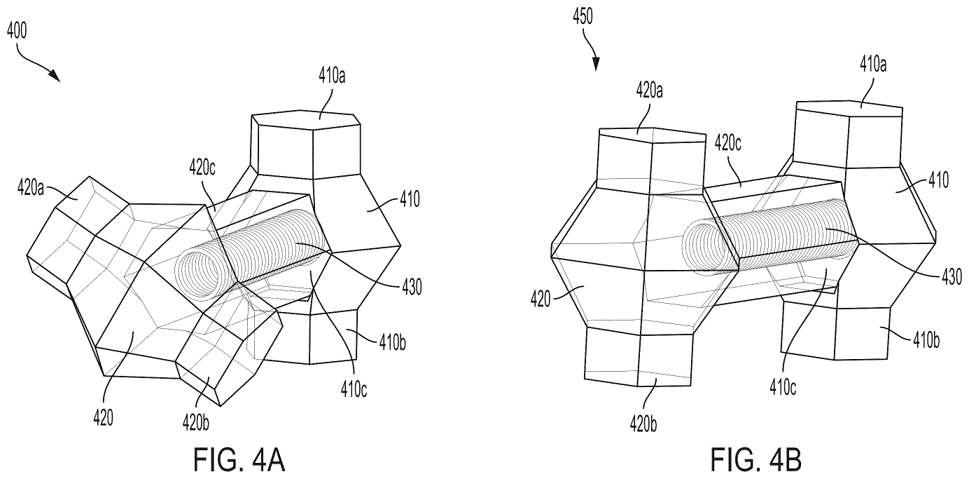

FIGS. 4A-4B illustrate wireframes of a joint with two joint components in two rotational positions 400 and 450. Referring first to FIG. 4A, the joint may include a first joint component 410 and a second joint component 420. The first joint component 410 may include two joint component protrusions 410a and 410b that allow other components of an arm mount, such as the arm segment 320 of FIGS. 3A-3B, to attach and secure to the first joint component 410. As described above with respect to FIGS. 3A-3B, the joint component protrusions 410a and 410b may interface with joint recesses of another component like the arm segment 320 to allow the arm segment to attach and secure to the first joint component 410. The first joint component 410 may also include a female joint interface 410c, which may be a recessed section that interfaces with a corresponding protrusion of the second joint component 420 to allow the first joint component to attach and secure to the second joint component.

Similarly, the second joint component 420 may also include two joint component protrusions 420a and 420b that allow other components, such as the arm segment 320, to attach and secure to the second joint component 420. In various embodiments, the two joint component protrusions 420a and 420b of the second joint component 420 may function similarly as the joint component protrusions 410a and 410b of the first joint component 410 as described above. The second joint component 420 may also include a male joint interface 420c, which may be a protrusion that interfaces with the female joint interface 410c of the first joint component 410. The male joint interface 420c may be inserted into the female joint interface 410c to attach the two joint components 410 and 420 together.

It may also be noted that the joint component protrusions 410a, 410b, 420a, 420b, as well as the female joint interface 410c and the male joint interface 420c of the first and second joint components 410 and 420 may be structured in the shape of a hexagon. With the hexagon shape of the female and male joint interfaces 410c and 420c, when the joint interfaces interact with each other, the contact between the hexagonal surfaces of the joint interfaces 410c and 420c may reduce the possibility of the interfaces disengaging due to slip, where the joint interfaces slide away from each other. The female and male joint interfaces 410c and 420c may also be implemented with various materials to further reduce the possibility of slip. For example, the joint interfaces 410c and 420c may be implemented using plastic, which when combined with the hexagonal shape of the joint interfaces 410c and 420c, may reduce the possibility of slip due to slip needing to shear through the plastic for slip to occur. While the joint interfaces 410c and 420c are attached to one another, the plastic of the joint interfaces may be compressed, which may mean the plastic will more likely become dented then be sheared through, thus reducing the chance of slip. The joint component protrusions 410a, 410b, 420a, and 420b may also have a hexagonal shape and interact with a corresponding joint recess with the same shape in a component like the arm segment 320, which may also help reduce the chance of slip between the joint components 410 and 420 and the components attached to them, such as the arm segment 320. It may be noted that the joint interfaces 410c and 420c, as well as the joint component protrusions 410a, 410b, 420a, and 420b may be illustrated with hexagon shapes, the shape of those parts may also be implemented in the shape of various other polygons, such as an octagon. In various embodiments, the number of sides of the polygon used may also affect the stability of the attachment as polygons with more sides may further reduce the possibility of slip.

Referring back to FIG. 4A, the joint may also include a retainer 430 that extends from the male joint interface 420c through the female joint interface 410c to secure the first and second joint components 410 and 420. In various embodiments, the retainer 430 may be implemented as various fasteners, such as a screw or bolt. The retainer 430 may be threaded through a bore of the female joint interface 410c which forces the male and female joint interfaces 410c and 420c together and also secures them together. The retainer 430 may reinforce the joint by reinforcing the connection between the first and second joint components 410 and 420. The retainer 430 may provide more structural support to the joint to be able to support higher load and torque forces applied to the joint, which may help improve performance and reduce the possibility of problems such as cantilever bending.

FIG. 4B illustrates the second joint component 420 in a different configuration as a result of being rotated relative to the first joint component 410. This means that the first and second joint components 410 and 420 may rotate relative to one another, but also that components attached to the joint component protrusions 410a, 410b, 420a, and 420b may rotate about their attachment point to the joint component protrusions, as described above with respect to FIGS. 3A-3B. In the example as illustrated in FIGS. 4A-4B, rotating the second joint component 420 relative to the first joint component 410 may include detaching the joint components from each other by unthreading the retainer 430 out of the bore of the female joint interface 410c and separating the joint interfaces 410c and 420c, rotating the second joint component 420 to a new position, and then reattaching the joint components by joining the joint interfaces and then threading the retainer 430 through the bore of the female joint interface 410c.

Various embodiments may implement the retainer 430 in different manners that may allow the second joint component 420 to be rotated relative to the first joint component 410 without needing to completely detach the joint components from one another. Different embodiments may also implement the retainer 430 at different locations than the one illustrated as appropriate depending on the specific retainer used. For example, the retainer 430 may be implemented as a Bayonet Neill-Concelman (BNC) connector which may allow the first and second joint components 410 and 420 to be engaged and disengaged by rotating the components. The retainer 430 may also be implemented as a spring lock which may allow the joint components 410 and 420 to be engaged and disengaged by compressing and pulling the components. The retainer 430 may also be implemented as a cam that is accessible from the surface of the joint components that do not interface with each other which may allow the joint components 410 and 420 be engaged and disengaged by activating the cam to obtain the necessary slack to rotate the components before re-activating the cam to secure the components in place. The retainer 430 may also be implemented as a flip lever that is also accessible from the surface of the joint components 410 and 420 that do not interface with each other, which may allow the joint components to be engaged and disengaged by activating the lever.

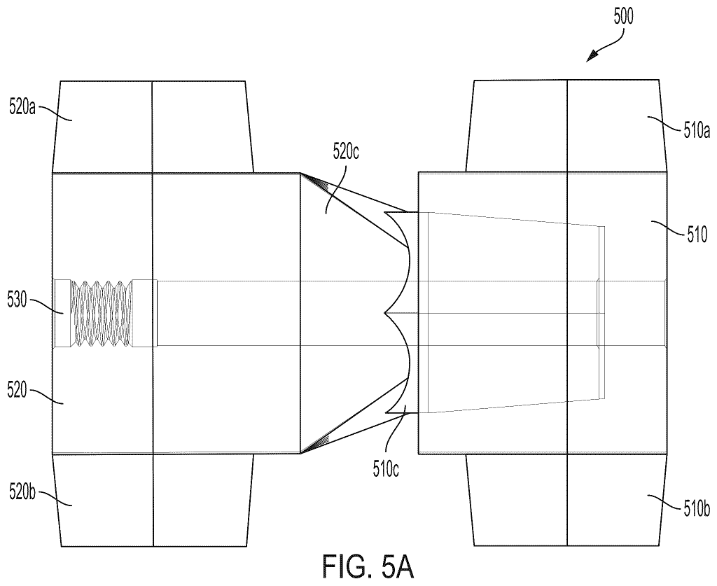

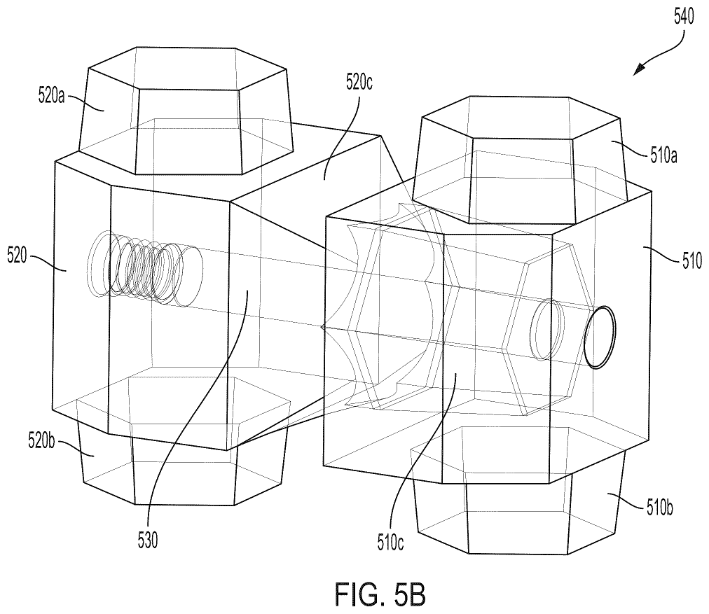

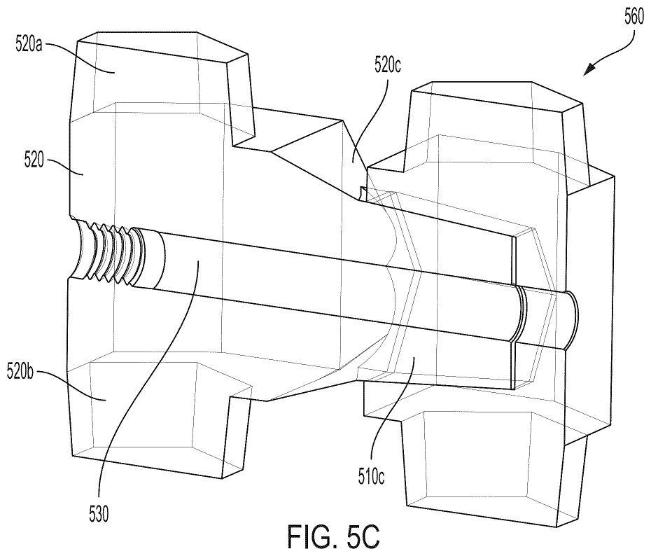

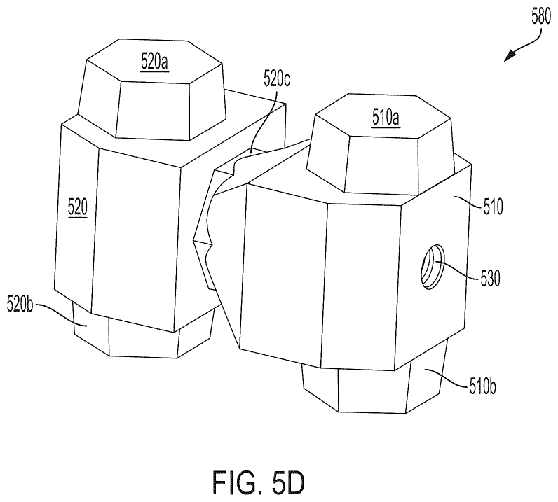

FIG. 5A illustrates a side view wireframe of a joint with two joint components. The joint may include a first joint component 510 that includes joint component protrusions 510a and 510b where other components may attach to the joint component. The first joint component 510 may also include a female joint interface 510c that is a recessed section that interfaces with a corresponding protrusion of the second joint component 520. The second joint component 520 may also include joint component protrusions 520a and 520b where other components may attach to the joint component and may also include a male joint interface 520c that is another protrusion for interfacing with the recess of the female joint interface 510c. The joint may also include a retainer 530 that extends through the first and second joint components 510 and 520 and may help secure the joint components together. In various embodiments, the joint components 510 and 520, as well as their constituent parts, may correspond to the joint components 410 and 420 of FIGS. 4A-4B.

The male and female joint interfaces 510c and 520c may also be drafted with slight tapers, such as a taper of five degrees. That is, with the joint interfaces 510c and 520c implemented as hexagonal shapes, each face of the joint interfaces may be drafted with a slight taper. The taper may provide a clearance between the back plane of the female joint interface 510c and the front face of the male joint interface 520c when the joint interfaces interact with each other. When the joint interfaces 510c and 520c are then forced together by the retainer 530, all the sides of the male joint interface 520c may impinge on the walls of the female joint interface 510c, which helps reduce the possibility of slip between the joint components 510 and 520.

FIG. 5B illustrates a perspective view wireframe of two joint components 510 and 520 with a male and female joint interface 510c and 520c, and FIG. 5C illustrates a perspective view wireframe of the cross-section of two joint components 510 and 520 with the male and female joint interfaces. FIG. 5D illustrates a perspective view of the joint components 510 and 520 with a male and female join interface. As described above, the first joint component 510 with the female joint interface 520c may include a bore where the retainer 530 extends through to secure the first and second joint components 510 and 520 together.

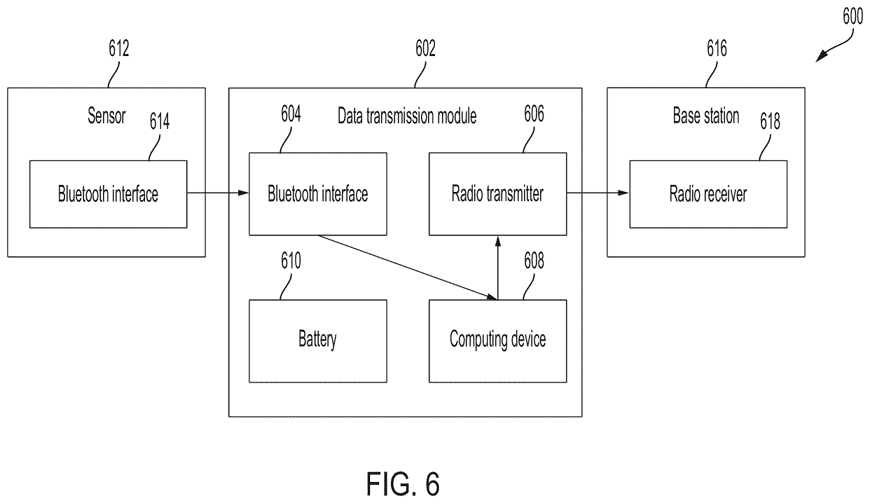

FIG. 6 illustrates a schematic 600 of a data transmission module 602 that transfers data from a sensor 612 to a base station 616. In various embodiments, the data transmission module 602 may correspond to the computing system 140 of FIG. 1A. That is, the data transmission module 602, and its constituent parts, may be attached to an aerial vehicle. The data transmission module 602 may include a Bluetooth interface that communicates with the Bluetooth interface 614 of the sensor 612 to receive sensor data from the sensor 612. Although a Bluetooth interface 604 is illustrated and described herein, various embodiments of the data transmission module 602 may include a different interface for communicating with the sensor 612 and may depend on what communication channel the sensor 612 is configured to communicate over, which may be Zigbee or near field communication (NFC), among others. The sensor 612 may be an existing off-the-shelf handheld sensor that is preconfigured for use by an individual. The data transmission module 602 may communicate with the sensor 612 to adapt the sensor 612 to be able to support longer range data transmission without needing to make any adjustments to the sensor 612 itself.

The data transmission module 602 may also include a radio transmitter 606 that communicates with a radio receiver 618 of a base station 616 to transmit the sensor data received from the sensor 612 to the base station 616. In various embodiments, the radio transmitter 606 and radio receiver 618 may operate using low-power long-range (LoRa) radio. Because the radio transmitter 606 and the radio receiver 618 may communicate via radio waves, this may also allow the data transmission module 602 to be able to transmit sensor data to the base station 616 even if an internet connection is not available. In various embodiments, the base station 616 may be any component capable of receiving and processing the data transmitted from the radio transmitter 606, such as a server or a computing device. Similar to the Bluetooth interface 604, the radio transmitter 606 may be various different communication interfaces depending on the communication channel used by the base station 616. More generally, the data transmission module 602 may include two communication interfaces: a first communication interface that communicates with the sensor 612 over a first communication channel to receive sensor data and a second communication interface that communicates with the base station 616 over a second communication channel to transmit the sensor data to the base station.

The data transmission module 602 may allow the sensor data generated by the sensor 612 to be transmitted in real-time to the base station 616 even if the base station 616 is positioned outside the communication range of the sensor 612. That is, the sensor 612 may be configured to communicate via a communication channel that has a certain effective communication range, such as the limited range of Bluetooth communication, but the base station 616 may be located outside that effective communication range of that communication channel, such as being located outside the range of the Bluetooth connection to the sensor 612. In such cases, the data transmission module 602 may receive the sensor data from the sensor 612 via the communication channel with limited range that the sensor 612 communicates over, and then transmit that sensor data over a communication channel with a longer communication range, such as long range radio, to the base station 616.

Referring back to FIG. 6, the data transmission module 602 may include a computing device 608 that is communicatively coupled to the Bluetooth interface 604 and the radio transmitter 606. The computing device 608 may be a single-board computer, such as a Raspberry Pi, in order to limit the overall size of the data transmission module 602 to allow the module to be attached or mounted as a payload to various support structures, such as the aerial vehicle 110 of FIG. 1A-1B. The computing device 608 may include a processor, memory, storage, and communication ports, which may allow the computing device 608 to communicate with both the Bluetooth interface 604 and the radio transmitter 606. The computing device 608 may convert the sensor data from Bluetooth signals when it was received by the Bluetooth interface 604 to radio waves so the radio transmitter 606 may transmit the sensor data as radio waves to the radio receiver 618. In various embodiments, the computing device 608 may encrypt the sensor data when converting the data to radio waves to increase data security. The data transmission module 602 may also include an integrated battery 610 that provides power to the other components of the module. Various embodiments of the data transmission module 602 may include an integrated battery, but other embodiments may include a power interface component that allows the data transmission module 602 to plug into an external data source. The various components of the data transmission module 602 may be implemented on a single chip, and thus may be implemented as a system on chip (SoC).

In various embodiments, the configuration of the data transmission module 602 may allow the module to be positioned in the proximity of the sensor 612 to be able to receive the sensor data via the limited range communication channel used by the sensor 612, such as Bluetooth, and then transmit that sensor data using a longer range communication channel to the base station 616. Using the example of the aerial vehicle 110 of FIGS. 1A-1B, the sensor 612 may be mounted as a payload of the aerial vehicle via the adjustable arm mount 120. This may allow the sensor 612 to be carried to various locations by the aerial vehicle 110 to generate sensor data for those different locations. The data transmission module 602 may also be attached to the aerial vehicle 110, such as at the location of the computing system 140. This allows the data transmission module 602 to always be in proximity to the sensor 612 even as the sensor 612 is carried to different locations.

As the aerial vehicle 110 carries the sensor 612 to various locations, the base station 616 may leave the communication range supported by the communication channel of the sensor 612. That is, the base station 616 may leave the Bluetooth range of the sensor 612. As a result, the base station 616 may no longer be able to receive the sensor data via the built-in communication channel of the sensor 612. However, because the data transmission module 602 may remain in the proximity of the sensor 612 as a result of also being attached to the aerial vehicle 110, the Bluetooth interface 604 of the data transmission module 602 may still be able to receive the sensor data from the sensor 612. As such, the data transmission module 602 may receive the sensor data as Bluetooth signals, convert the Bluetooth signals to radio waves via the computing device 608, and then transmit the sensor data as the radio waves to the radio receiver 618 of the base station 616. In this way, the base station 616 is able to continue to receive the sensor data from the sensor 612 even if the base station 616 is no longer in communication range with the sensor 612.

Additionally, because the computing and communication interfaces may be integrated into the data transmission module 602, the data transfer via the data transmission module 602 may not include any software or communication associated with the support structure that the sensor 612 and/or the data transmission module is mounted or attached to, such as the aerial vehicle 110. In other words, while the aerial vehicle 110 may include integrated communication channels that are also able to transmit data, the data transmission module 602 does not rely on those communication channels of the aerial vehicle 110 and are instead able to receive and transmit the sensor data only with the components included in the data transmission module itself. This may increase the security of the sensor data as the data would only be processed by the data transmission module 602.

The radio transmitter 606 and radio receiver 618 may also be configured to operate on particular radio frequencies to improve the reliability of the radio connection between the data transmission module 602 and the base station 616. Specifically, the radio transmitter 606 and the radio receiver 618 may operate on a radio frequency on the order of 900 megahertz (e.g., 950 megahertz). Operating on this frequency may reduce the interference from commercial devices that may operate on different radio frequencies. As a result, the radio transmitter 606 may be able to transmit sensor data as radio waves to the radio receiver 618 even in crowded environments where there may be many other radio devices, such as commercial events or large gatherings of people.

The data transmission module 602 may also be surrounded by an enclosure to protect the module from various potential electrical hazards. The enclosure may be made of insulated material to reduce electrical discharges from the data transmission module 602. In various embodiments, the sensor 612 may be used to generate sensor data in environments that may include various flammable or explosive substances. With the data transmission module 602 also being positioned in those environments, it may be necessary to reduce the chance that an electrical spark from the data transmission module 602 ignites anything in the environment. The data transmission module 602 may be completely sealed inside of the enclosure but remain capable of communicating wirelessly with the sensor 612 to receive the sensor data and then to transmit the sensor data to the base station 616.

In various embodiments, the base station 616 may include a Global Positioning System (GPS) receiver that communicates with various satellites to receive the GPS locations of the sensor 612. As the base station 616 receives the sensor data via the radio receiver 618 from the data transmission module 602, the base station may associate the sensor data to the current GPS location of the sensor 612. In doing so, the base station 616 may create a spatial representation of where various sensor data was detected by the sensor 612.

Although the schematic 600 is illustrated with a single sensor 612 and data transmission module 602, in various embodiments, multiple sensors 612 and data transmission modules 602 may generate and transmit data to the same base station 616. That is, one or more sensors 612 and data transmission modules 602 may be mounted to different aerial vehicles 110. As the aerial vehicles carry their respective sensor 612 and data transmission module 602 to various locations, some of which may result in the base station 616 leaving the communication distance supported by the sensor 612, the data transmission module 602 attached to each of the aerial vehicles may continue to transmit the sensor data generated by the corresponding sensor 612 to the base station 616. This way, the base station 616 may be able to simultaneously receive real-time sensor data generated by multiple different sensors.

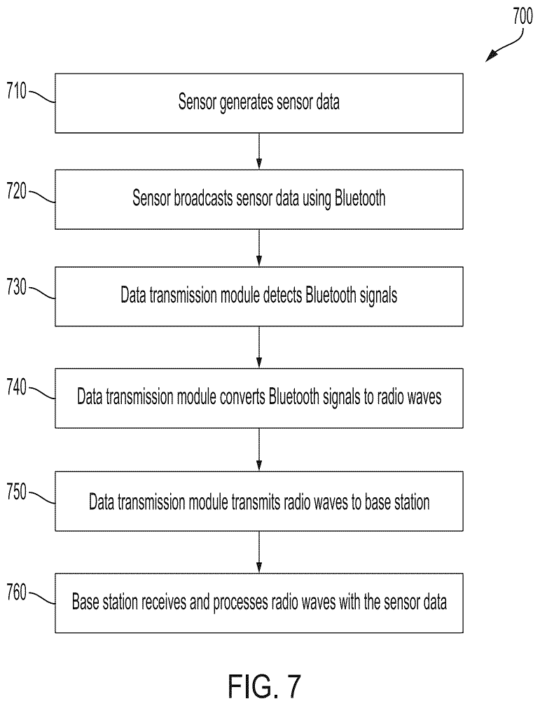

FIG. 7 illustrates a method 700 for transferring data from a sensor to a remote base station. Various steps of method 700 may be executed by various components illustrated in the schematic 600 of FIG. 6. The method 700 may include step 710 where a sensor, such as the sensor 612 measures various characteristics of its environment and generates corresponding sensor data. The sensor may then broadcast the sensor data as Bluetooth signals, such as via a Bluetooth interface 614 at step 720. At step 730, a data transmission module, such as 602, may detect the Bluetooth signals broadcasted by the sensor, and then convert the Bluetooth signals to radio waves at step 740. The radio waves may then be transmitted to a base station at step 750, where the base station then receives and processes the radio waves with the sensor data at step 760. In this way the base station may receive the sensor data generated by the sensors even if the base station is not in communication range with the sensor.

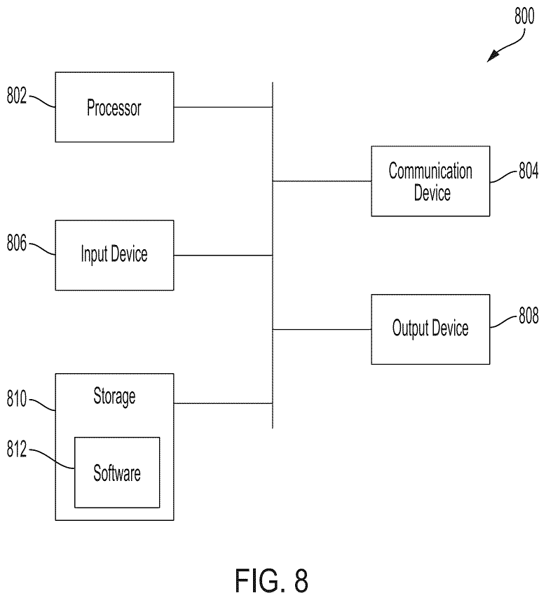

FIG. 8 illustrates an example of a computing system 800, in accordance with one or more examples of the disclosure. Computing system 800 can be a computer connected to a network. Computing system 800 can be a client computer or a server. As shown in FIG. 8, computing system 800 can be any suitable type of microprocessor-based device, such as a personal computer, workstation, server, or handheld computing device (portable electronic device) such as a phone or tablet, or dedicated device. The computing system can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides input, such as a touch screen, keyboard or keypad, mouse, or voice-recognition device. Output device 808 can be any suitable device that provides output, such as a touch screen, haptics device, or speaker.

Storage 810 can be any suitable device that provides storage, such as an electrical, magnetic, or optical memory, including a RAM, cache, hard drive, removable storage disk, or other non-transitory computer readable medium. Communication device 804 can include any suitable device capable of transmitting and receiving signals over a network, such as a network interface chip or device. The components of the computing system can be connected in any suitable manner, such as via a physical bus or wirelessly.

Processor(s) 802 can be any suitable processor or combination of processors, including any of, or any combination of, a central processing unit (CPU), field-programmable gate array (FPGA), and application-specific integrated circuit (ASIC). Software 812, which can be stored in storage 810 and executed by processor 802, can include, for example, the programming that embodies the functionality of the present disclosure (e.g., as embodied in the devices as described above).

Software 812 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by or in connection with an instruction execution system, apparatus, or device.

Software 812 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computing system 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computing system 800 can implement any operating system suitable for operating on the network. Software 812 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the endoscope of the disclosure and examples as defined by the claims. Finally, the entire disclosure of the patents and publications referred to in this application are hereby incorporated herein by reference.

1. An adjustable support comprising:
a plurality of support portions; and
at least one joint connecting adjacent support portions of the plurality of support portions and configured so that the adjacent support portions can be positioned in different positions relative to one another,
the at least one joint comprising a first portion and a second portion, the first portion comprising a polygonal extension and the second portion comprising a polygonal recess for receiving the polygonal extension of the first portion, wherein the polygonal extension can be received in the polygonal recess in different rotational positions to position the adjacent support portions in the different positions relative to one another,
the at least one joint further comprising a retainer to force the first and second portions together.

2. The adjustable support of claim 1, wherein the adjacent support portions comprise a mount for mounting the adjustable support to a support structure.

3. The adjustable support of claim 2, wherein the support structure comprises a vehicle.

4. The adjustable support of claim 3, wherein the vehicle is an unmanned aerial vehicle (UAV).

5. The adjustable support of claim 4, wherein the mount is configured to mount to a leg of the UAV.

6. The adjustable support of claim 4, wherein the mount for mounting the adjustable support to a support structure is a first mount, and the adjustable support comprises a second mount for mounting a sensor so that the sensor can be carried by the UAV.

7. The adjustable support of claim 2, wherein the first portion of the joint or the second portion of the joint is formed into the mount.

8. The adjustable support of claim 1, wherein the first portion comprises a plurality of polygonal extensions.

9. The adjustable support of claim 1, wherein the second portion comprises a polygonal extension.

10. The adjustable support of claim 1, wherein the adjacent support portions comprise an arm member that comprises a polygonal recess for receiving an additional polygonal extension of the first portion of the joint or the second portion of the joint.

11. The adjustable support of claim 10, wherein the adjacent support portions comprise two arm members extending in parallel, wherein each arm member comprises a polygonal recess for receiving a corresponding additional polygonal extension of the first portion of the joint or the second portion of the joint.

12. A system for transferring data from one or more sensors to a remote receiving station, the system comprising:
a first communication interface for communicating with the one or more sensors via a first communication channel, wherein the first communication channel is capable of transmitting data at a first distance;
a second communication interface for communicating with the remote receiving station via a second communication channel, wherein the second communication channel is capable of transmitting data at a second distance greater than the first distance; and
a computing device coupled to the first and second communication interfaces and configured to receive sensor data from the one or more sensors via the first communication interface, wherein the sensor data is received in a first format corresponding to the first communication channel, wherein the computing device is configured to convert the sensor data from the first format to a second format corresponding to the second communication channel, and wherein the computing device is further configured to transmit the sensor data in the second format to the remote receiving station via the second communication interface.

13. The system of claim 12, wherein the first communication channel is a Bluetooth channel.

14. The system of claim 12, wherein the second channel is a low-power long-range (LoRa) radio channel.

15. The system of claim 12, wherein an intervening distance between the one or more sensors and the remote receiving station is greater than the first distance and less than or equal to the second distance.

16. The system of claim 12, wherein the one or more sensors are mounted to an unmanned aerial vehicle (UAV).

17. The system of claim 16, wherein the second communication channel is separate from a software module or communication module associated with the support structure.

18. The system of claim 16, wherein one or more of the first communication interface, the second communication interface, and the computing device are mounted to the UAV.

19. The system of claim 16, further comprising a battery that supplies electrical power to one or more of the first communication interface, the second communication interface, and the computing device, wherein the battery is separate from the UAV.

20. The system of claim 12, wherein the remote receiving station comprises software to associate a Global Positioning System (GPS) location of the one or more sensors to the sensor data, wherein the GPS location corresponds to where the sensor data was generated by the one or more sensors.

21. The system of claim 12, further comprising an enclosure around one or more of the first communication interface, the second communication interface, and the computing device to protect against electrical hazards.

22. The system of claim 12, wherein the computing device is a system-on-chip (SoC).
